(19) United States
(12) Patent Application Publication
(10) Pub. No.: US 2010/0052443 A1
(43) Pub. Date: Mar. 4, 2010

(54) Sphere generator layers

(75) Inventor: Young Ho Ro, Glen Burnie, MD (US)

Correspondence Address: Young Ho Ro, 201 North Crain Highway, Apt. 4M, Glen Burnie, MD, 21061, US

(73) Assignee: Young Ho Ro, Glen Burnie, MD (US)

(21) Appl. No.: 12/457,071

(22) Filed: Jun. 1, 2009

Related U.S. Application Data
(60) Provisional application No. 61/136,422, filed on Sep. 4, 2008.

(51) Int. Cl. H02K 7/116; H02K 21/00

(52) U.S. Cl. 310/83; 310/152

(57) ABSTRACT

New design of generator and or generators, which creates electricity. Using a sphere shape design compared to the traditional generator designs already in use today. Using a sphere shape design for the placements of the magnets and coils. The gears will allow for multiple layers to be used for rotation, dependent on power needs.

### CLAIM OF PRIORITY

This application claims the benefit of U.S. Provisional Application Ser. No. 61/136,422, filed on Sep. 4, 2008, the entire contents of which are hereby incorporated by reference.

### DESCRIPTION

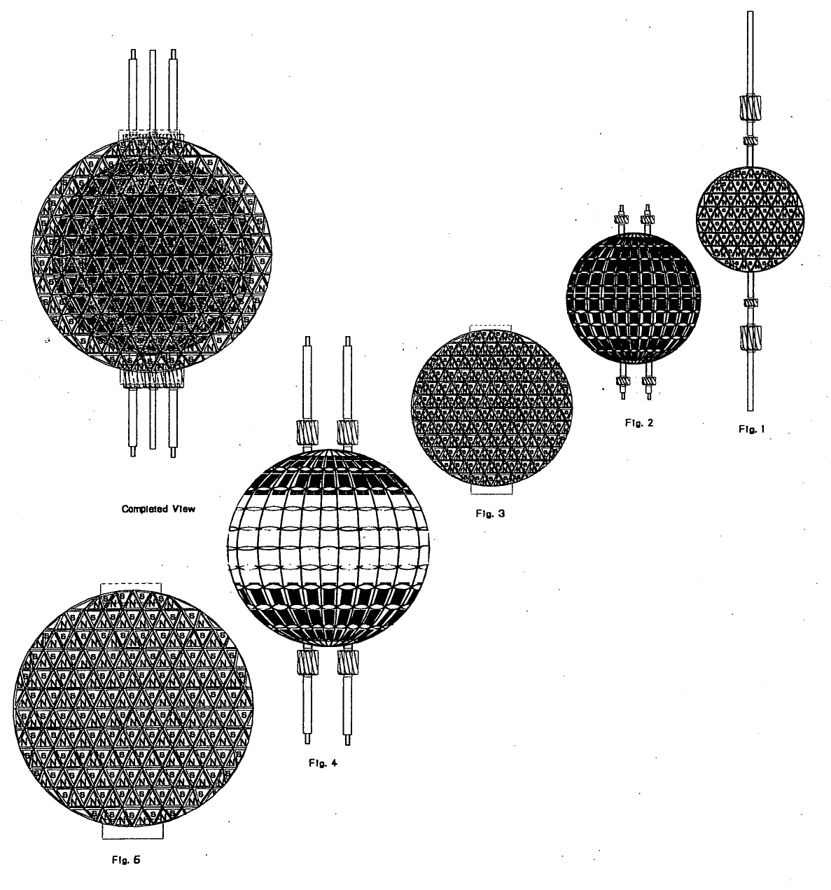

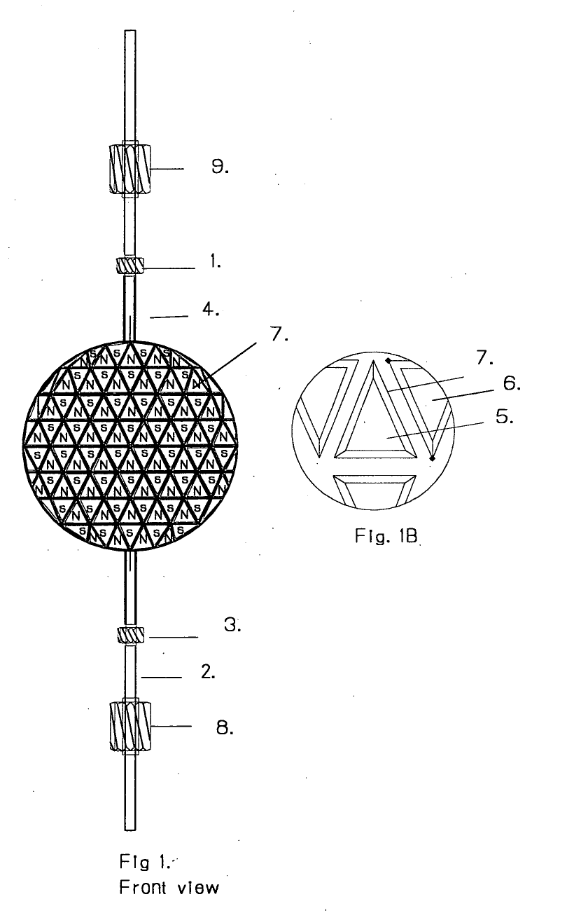

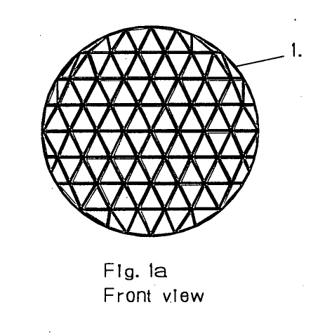

FIG. 1 shows the magnet sphere, known as magnet sphere 1. Which consist of a sphere shape metal framing (FIG. 1a) around a light weight sphere shaped material, connected by a support rod, that provide the external force needed to rotate the magnet sphere 1. FIG. 1 shows gear 1 and gear 2 connected to the support rod at both ends. The external force moves the magnet sphere 1 to a clockwise rotation. FIG. 1 also shows the placement of the magnets, which are arranged in a north, south order, within the given roll.

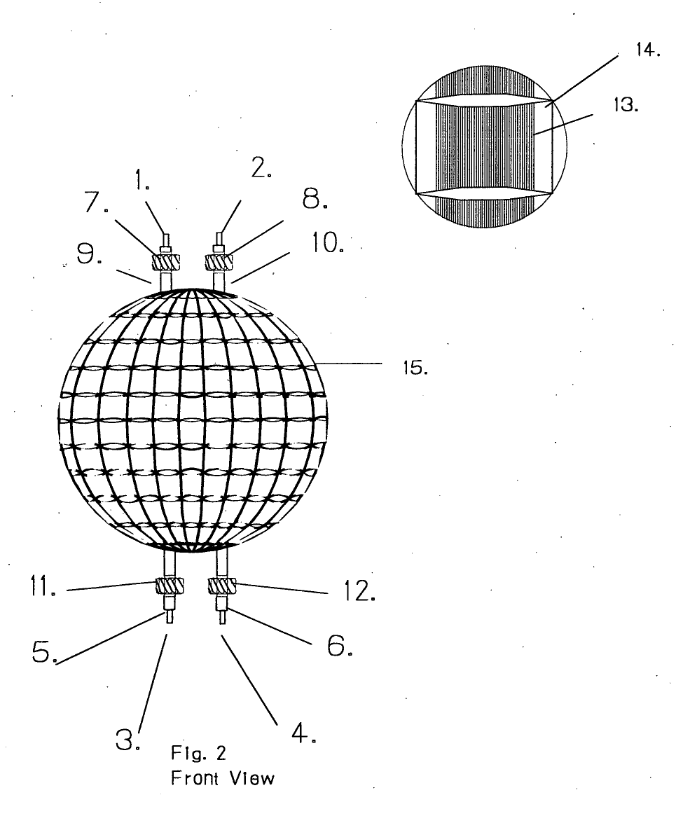

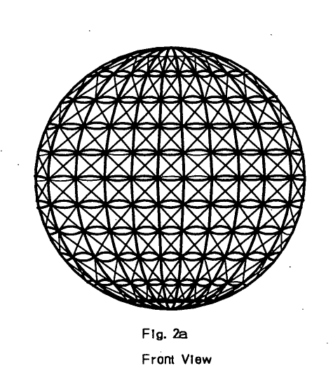

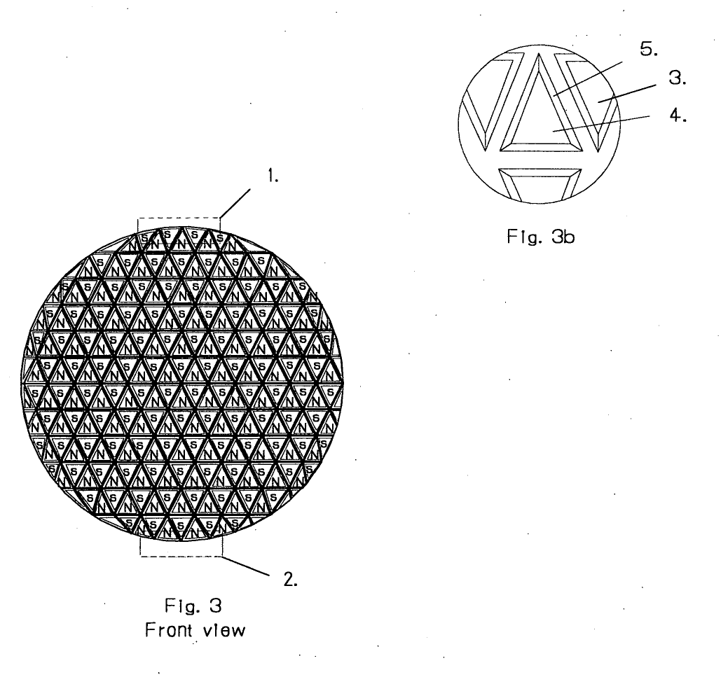

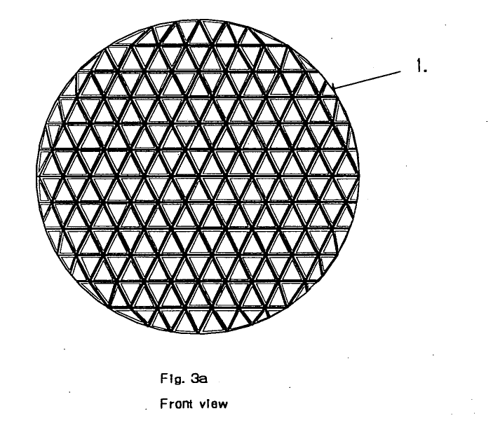

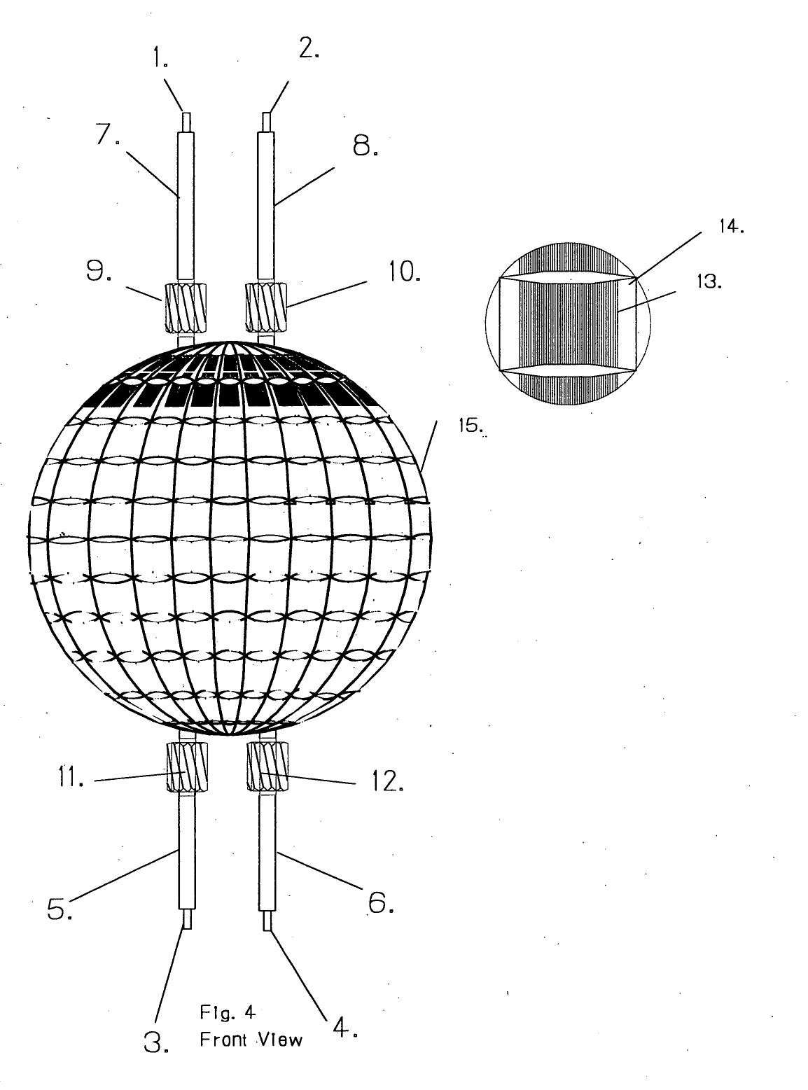

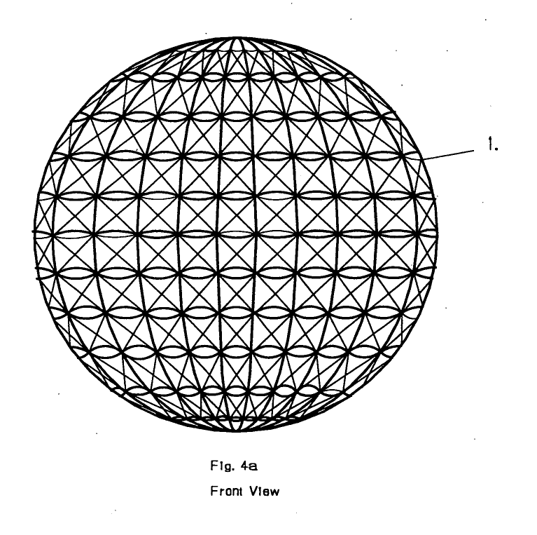

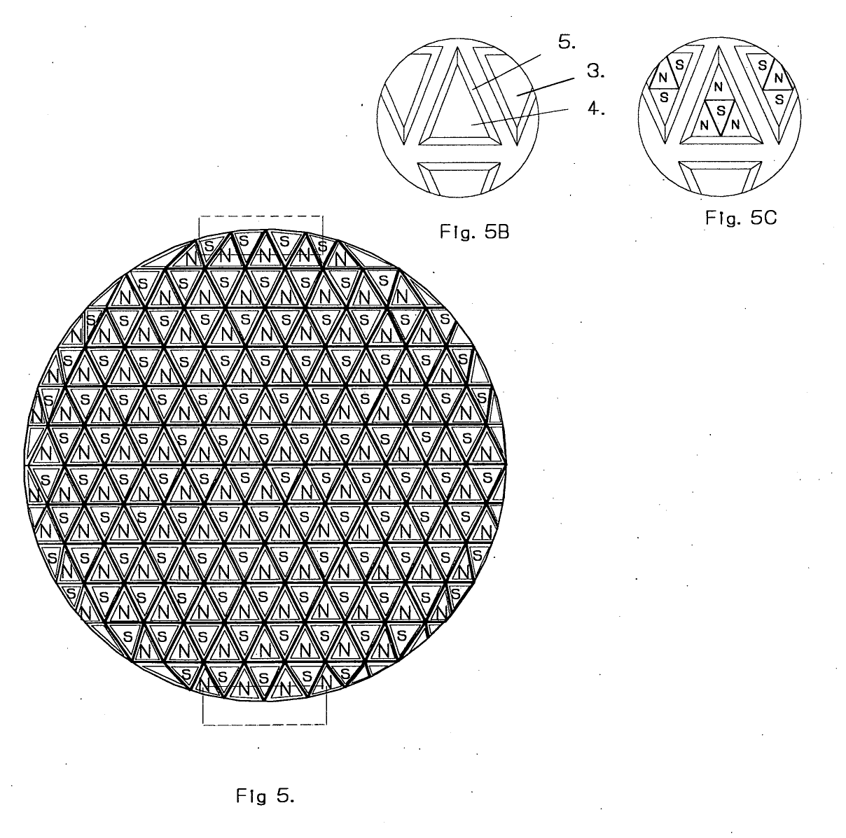

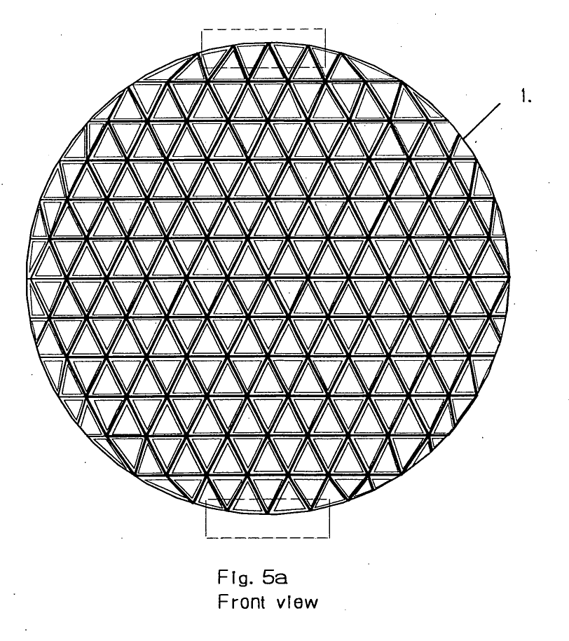

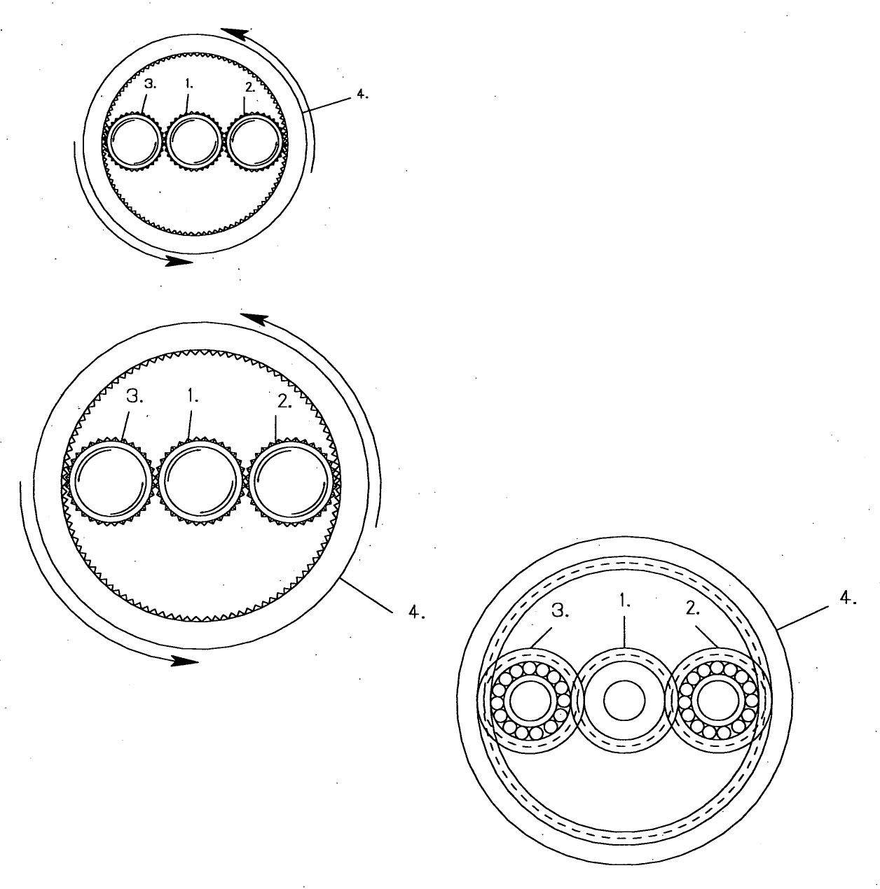

FIG. 2 shows a ceramic sphere framing (FIG. 2a), which supports the copper wiring. Which is placed around the magnet sphere 1. Each copper wire coil, is connected to the opposite corresponding copper wire coil and or will remain independent. Positioning will be determined during testing, either at the opposite end of the corresponding top or bottom, left or right hemisphere or within the same hemisphere. Each section of coils may also be independent. (Positive to one rod 1 and negative to the other rod 2. The next coil connected to the rods, negative to rod 1 and positive to rod 2.) The positive and negative, will be determined by the inter sphere. And as long as there is a draw from the Rod 1 and Rod 2, with less resistance, the electron will not flow to the next coil. Without using a commutator. Which ever generates the highest power output. To be determined during testing. Rods tubes 1 and 2 are fixed on top of the top hemisphere, with gear 1 and gears 2 connected. Within rod tubes 1 and 2, are rods 1 and 2, which is the output for the corresponding hemisphere. Rods tubes 3 and 4 are fixed on the bottom of the bottom hemisphere, with gear 3 and gear 4 connected. Within rod tubes 3 and 4, are rods 3 and 4, which is the output for the corresponding hemisphere. Gears 1, 2, 3, and 4 rotate freely without movement of the coil sphere. Gears 1 and 2 are connected to magnet sphere gear 1, and gear 3 and 4 are connected to magnet cylinder gear 2. This will cause ceramic gears 1 and 2 to rotate counterclockwise to magnet sphere gear 1, which rotates clockwise and cylinder gear 3 and 4 also rotates counterclockwise to magnet sphere 2, which rotates clockwise, as the ceramic coil sphere remains still. (shown on Page 12)
FIG. 3 shows the magnet sphere, known as magnet sphere 2. Which also consist of a sphere shape metal framing (FIG. 3a), fixed around the wire coil. Fixed on the top and bottom of the magnet sphere 2, are gear 1 and gear 2, which rotates the magnet sphere 2 counterclockwise. The placement of the magnets arranged to the corresponding magnetic field of the magnet sphere 1, all within the inside of magnet sphere 2. If needed, magnets can be placed on the outside of the sphere to create multiple layers.
FIG. 4 shows another coil sphere, known as sphere coil 2. This is to increase power output. Components are similar to the FIG. 2, with it's corresponding gear as shown page 8.
FIG. 5 shows another magnet sphere 3, fixed around the sphere coil 2. With its similar gears as magnet sphere 2. As shown on page 10.

Page 12 shows the rotation of the gears as stated with gear FIG. 1, gears FIG. 2, and gear FIG. 3. Also shows the rotation of the gears as stated with gear FIG. 1, gears FIG. 4, and FIG. 5. This rotation of the gears will rotate the corresponding sphere.

Function:

The rotation of the magnet sphere 1 and the rotation of magnet sphere 2, creates the electricity when it passes the corresponding copper wire coil.

1. Using a sphere shape design compared to the traditional generator designs already in use today.

2. Using a sphere shape design for the placements of the magnets and coils. The gears will allow for multiple layers to be used for rotation, dependent on power needs.
